(19) United States
(12) Patent Application Publication
(10) Pub. No.: US 2015/0334302 A1
(43) Pub. Date: Nov. 19, 2015

(54) Object Exterior Photographing System

(71) Applicant: Sheenwill International (Hong Kong) Limited, Kowloon (HK)

(72) Inventor: Kin Ying WONG, Kowloon (HK)

(21) Appl. No.: 14/711,614

(22) Filed: May 13, 2015

(30) Foreign Application Priority Data
May 17, 2014 (CN) 201420254504.1

(51) Int. Cl. H04N 5/232; G06T 1/00

(52) U.S. Cl. CPC H04N 5/23238; H04N 5/23296; G06T 1/0007

(57) ABSTRACT

The utility model discloses an object exterior photographing system comprising an electronic transmitter, a camera and an electronic turn-plate. The electronic turn-plate is connected with the electronic transmitter to be a wireless access through Wi-Fi connection, so that the electronic turn-plate can rotate in sync with photographing of the camera, and multi-angle images of an object can be simply and accurately taken.

### TECHNICAL FIELD

The utility model relates to an object exterior photographing system.

### BACKGROUND OF THE INVENTION

To date, information technology has much developed. However, only one picture of a product is hard to impress customers during advertising and popularizing, whereupon a 360-degree exterior photographing systems is developed. The 360-degree exterior photographing systems in the prior art are mainly classified into two categories. One of the categories achieves a 360-degree panoramic image of a product to be photographed on a turn-plate depending on photographing from different angles and synthesizing the pictures with software, but in this category, a turn-plate, a digital camera and software are independently and manually operated, photographing cannot be completely in sync with the turn-plate in the absence of accurate turn-plate positioning technology, so error in operational and photographing accuracy is inevitable, the 360-degree panoramic image produced is uncertain and operation process is very complicated. In the other category, synchronous photographing is realized by using a computer to connect a turn-plate with a digital camera through data cables, and only computer and relevant operation software can run; images or pictures can be synchronized but operations are very complicated. Therefore, the prior art requires improvement.

### SUMMARY OF THE INVENTION

The utility model aims to overcome defects of the prior art and provides an object exterior photographing system capable of simple and accurate photography for the object in different angles.

The object exterior photographing system comprises a camera, an electronic turn-plate and an electronic transmitter. The camera is used for photographing an object to be photographed. The electronic turn-plate having a WIFI signal receiving function comprises a rotary platform used for arranging the object to be photographed and driving the said to rotate. The electronic transmitter comprises a WIFI module capable of transmitting WIFI signals and an instruction module for setting instructions.

The electronic transmitter is wirelessly connected with the electronic turn-plate through the WIFI signals transmitted by the WIFI module. When a shutter of the camera is triggered, the electronic transmitter transmits an instruction to the electronic turn-plate so as to control the electronic turn-plate to rotate by an assigned angle in sync with photographing of the camera according to a set mode of the instruction.

According to the object exterior photographing system, the camera is provided with a hot shoe port with a data and instruction transmitting function, the electronic transmitter is socketed with the hot shoe port through a build-in matching port, and the instruction module controls photographing parameters of the camera through a hot shoe.

According to the object exterior photographing system, the electronic transmitter is a computer with instruction module software.

According to the object exterior photographing system, the instruction module software is capable of synthesizing pictures or video information taken by the camera into image files which can freely rotate and zoom to show continuous object exteriors.

According to the object exterior photographing system, the computer is a tablet computer or a smart cellphone.

According to the object exterior photographing system, the assigned angle is 360 degrees.

According to the object exterior photographing system, the electronic turn-plate further comprises an infrared positioning module capable of accurately controlling the photographing angle of the camera.

According to the object exterior photographing system, the rotary platform of the electronic turn-plate rotates at constant speed.

According to the object exterior photographing system, the rotary platform of the electronic turn-plate rotates intermittently, and the camera photographs the object the instant the rotary platform stays still.

According to the object exterior photographing system, the shutter of the camera is triggered by the electronic transmitter or directly by a user.

According to the object exterior photographing system provided by the utility model, the electronic turn-plate is connected with the electronic transmitter to be a wireless access through Wi-Fi connection, so that the electronic turn-plate can rotate in sync with photographing of the camera, and multi-angle images of an object can be simply and accurately taken. As an improvement, the image files are processed in the embodiment 2 and synthesized into those which can freely rotate and zoom to show continuous object designs.

### BRIEF DESCRIPTION OF THE DRAWINGS

The following drawings are illustrated in order to better detail the structure of the utility model, among which

FIG. 1 is a schematic view of one embodiment of the object exterior photographing system;

FIG. 2 is an explosive view of the electronic turn-plate;

FIG. 3 is a schematic view of another embodiment of the object exterior photographing system.

### DETAILED DESCRIPTION OF THE INVENTION

The followings are concrete preferential embodiments elaborated with the attached drawings in order to better understand the object exterior photographing system.

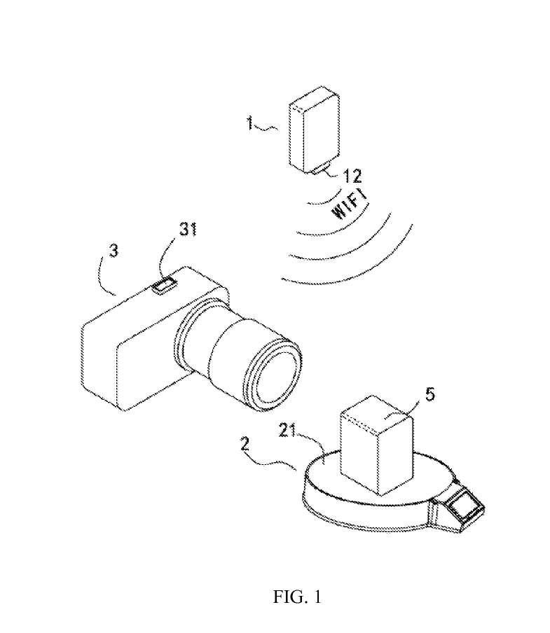

Shown as FIG. 1, the 360-degree object exterior photographing system in one of the embodiments comprises an electronic transmitter 1, a camera 3 and an electronic turn-plate 2.

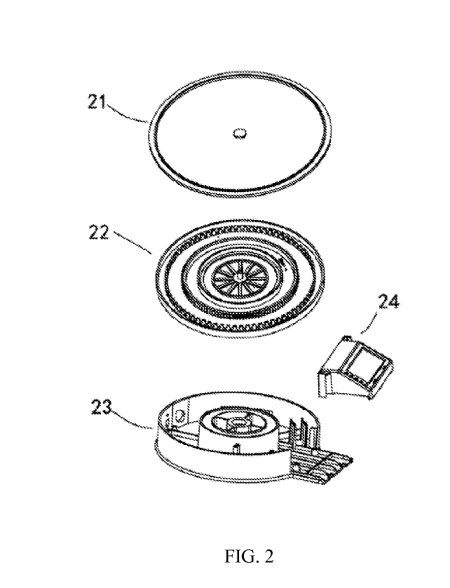

Shown as the explosive view of FIG. 2, the electronic turn-plate 2 comprises a bottom plate 23, a driving plate 22, a rotary platform 21 and an electronic module 24, wherein the driving plate 22, the rotary platform 21 and the electronic module 24 are mounted on the bottom plate 23, and the driving plate 22 is capable of driving the rotary platform 21 to rotate. The electronic module 24 comprises a WIFI module, an infrared positioning module and a sound indicator, wherein the WIFI module realizes WIFI connection and gives an instruction to control the driving plate 22 to rotate and the camera 3 to photograph and synchronize rotating of the rotary platform 21 with photographing of the camera 3. The infrared positioning module accurately controls rotation speed and angle of the rotary platform 21. The sound indicator is used for indicating rotation states of the rotary platform and sending sound alarms.

The electronic transmitter 1 comprises a WIFI module transmitting WIFI signals and an instruction module for instruction setting. The electronic transmitter 1 is wirelessly connected with the electronic turn-plate 2 through the WIFI signals transmitted by the WIFI module.

The camera 3 is used for photographing or recording and provided with a data and instruction transmitting port—a hot shoe 31. The hot shoe 31 is socketed with a matching port 12 of the electronic transmitter 1 so as to exchange photographing information or instructions. The electronic turn-plate 2 has a WIFI connection function and is wirelessly connected with the electronic transmitter through the WIFI signals so as to transmit the instructions.

The 360-degree object exterior photographing system is provided with a photographing mode and a recording mode. In the photographing mode, the number of the pictures taken in one circle can be set at 18, 36, 72 and more.

The 72-picture mode works like that: the instruction of the electronic transmitter 1 is set in an intermittent rotating mode rotating 72 times by 360 degrees. In this mode, the shutter of the camera is triggered, and the electronic transmitter 1 transmits the instruction to the electronic turn-plate 2, controls the rotary platform 21 to rotate to the initial position and sends a sound alarm. Then, the rotary platform 21 rotates 72 times intermittently by one circle according to the instruction, and the camera 3 synchronously takes 72 pictures of an object 5 to be photographed the instant the rotary platform 21 stays still. The sound indicator gives out an alarm at the start the shutter is triggered to prompt of starting photographing and sends alarms in each still moment of the intermittent rotation and at the finish point of the circle.

The recording mode works like that: the instruction of the electronic transmitter 1 is set in the recording mode. In the recording mode, the shutter of the camera is triggered, and the electronic transmitter 1 transmits the instruction to the electronic turn-plate 2, controls the rotary platform 21 to rotate to the initial position and sends a sound alarm. Then, the rotary platform 21 rotates intermittently by one circle at the constant speed according to the instruction, and simultaneously, the camera 3 records video of the object 5 to be photographed synchronously. The sound indicator gives out an alarm at the start the shutter is triggered to prompt of starting photographing and sends an alarm at the finish point of the circle.

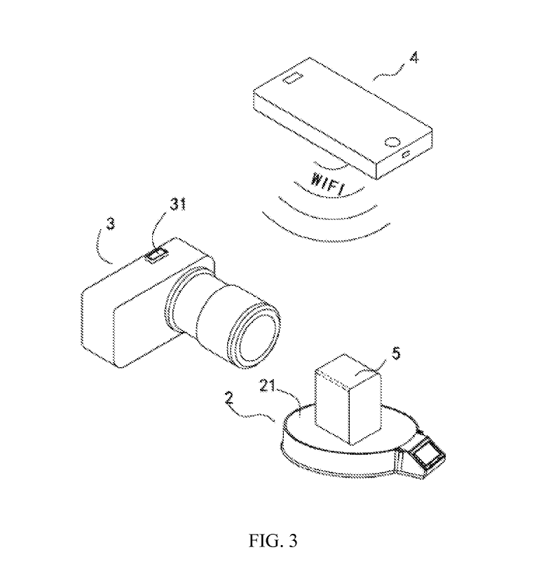

Shown as FIG. 3, the 360-degree object exterior photographing system in another embodiment comprises an electronic transmitter, a smart cellphone 4, a camera 3 used for photographing or recording, and an electronic turn-plate 2.

The electronic turn-plate 2 has the structure and the theory basically same as those of the former embodiment, see the explosive view of FIG. 2. The electronic turn-plate 2 comprises a bottom plate 23, a driving plate 22, a rotary platform 21 and an electronic module 24, wherein the driving plate 22, the rotary platform 21 and the electronic module 24 are mounted on the bottom plate 23, and the driving plate 22 is capable of driving the rotary platform 21 to rotate. The electronic module 24 comprises a WIFI module, an infrared positioning module and a sound indicator, wherein the WIFI module realizes WIFI connection and gives an instruction to control the driving plate 22 to rotate. The infrared positioning module accurately controls rotation speed and angle of the rotary platform 21. The sound indicator is used for indicating rotation states of the rotary platform and sending sound alarms.

The smart cellphone 4 comprises a WIFI module capable of transmitting WIFI signals and an instruction module for instruction setting. The smart cellphone 4 is wirelessly connected with the electronic turn-plate 2 through the WIFI signals transmitted by the WIFI module and photographs or records manually with the camera 3. The camera 3 synthesizes videos by computer software of the system through the obtained images and videos. The software synthesizes the pictures taken by the camera into the image files which can freely rotate and zoom to show object designs in 360 degrees.

Further, the smart cellphone could be replaced with a tablet computer or IPAD and the like.

The above elaborates the technical schemes provided by the embodiments and illustrates basic principles and embodiments of the present disclosure. The above descriptions are only applicable to making the principles and the structures of the embodiments more understandable. Those skilled in the art should appreciate that modifications and/or variations in any form made on the basis of the above embodiments and the application range all fall within the scope of the present disclosure.

1. An object exterior photographing system comprising a camera, an electronic turn-plate and an electronic transmitter, the camera being used for photographing an object to be photographed, the electronic turn-plate having a WIFI signal receiving function comprises a rotary platform used for arranging the object to be photographed and driving the said to rotate, the electronic transmitter comprises a WIFI module capable of transmitting WIFI signals and an instruction module for instruction setting, the electronic transmitter is wirelessly connected with the electronic turn-plate through the WIFI signals transmitted by the WIFI module, wherein when a shutter of the camera is triggered, the electronic transmitter transmits an instruction to the electronic turn-plate so as to control the electronic turn-plate to rotate by an assigned angle in sync with photographing of the camera according to a set mode of the instruction.

2. The object exterior photographing system according to claim 1, wherein the camera is provided with a hot shoe port with a data and instruction transmitting function, the electronic transmitter is socketed with the hot shoe port through a build-in matching port, and the instruction module controls photographing parameters of the camera through a hot shoe.

3. The object exterior photographing system according to claim 1, wherein the electronic transmitter is a computer with instruction module software.

4. The object exterior photographing system according to claim 3, wherein the instruction module software is capable of synthesizing pictures or video information taken by the camera into image files which can freely rotate and zoom and show continuous object designs.

5. The object exterior photographing system according to claim 3, wherein the computer is a tablet computer or a smart cellphone.

6. The object exterior photographing system according to claim 1, wherein the assigned angle is 360 degrees.

7. The object exterior photographing system according to claim 1, wherein the electronic turn-plate further comprises an infrared positioning module capable of accurately controlling the photographing angle of the camera.

8. The object exterior photographing system according to claim 1, wherein the rotary platform of the electronic turn-plate rotates at constant speed.

9. The object exterior photographing system according to claim 1, wherein the rotary platform of the electronic turn-plate rotates intermittently, and the camera photographs the object the instant the rotary platform stays still.

10. The object exterior photographing system according to claim 1, wherein the shutter of the camera is triggered by the electronic transmitter or directly by a user.
